(19) United States
(12) Patent Application Publication
(10) Pub. No.: US 2020/0062617 A1
(43) Pub. Date: Feb. 27, 2020

(54) METHOD AND APPARATUS FOR MINERALS AND WATER SEPARATION

(71) Applicant: US Metals Refining Group, Inc., Centennial, CO (US)

(72) Inventor: Henry W. Kasaini, Centennial, CO (US)

(21) Appl. No.: 16/547,541

(22) Filed: Aug. 21, 2019

Related U.S. Application Data
(60) Provisional application No. 62/720,308, filed on Aug. 21, 2018.

(51) Int. Cl. C02F 1/44

(52) U.S. Cl. CPC C02F 1/448; C02F 2103/08

(57) ABSTRACT

A method and apparatus for the treatment of wastewater streams to form purified water and a mineral-containing by-product. The wastewater stream may be a brine or produced water from an oil/gas extraction operation. The method includes passing the wastewater stream through a membrane assembly having a pervaporation membrane, whereby purified water vapor is collected from the permeate side of the membrane. A mineral-rich product may be recovered from the retentate, and/or a mineral-rich crystalline phase may deposit on the membrane and may be recovered as a solid from the membrane or may be washed off the membrane and collected.

### CROSS-REFERENCE TO RELATED APPLICATIONS

This application claims the priority benefit of U.S. Provisional Patent Application No. 62/720,308 by Kasaini and filed on Aug. 21, 2018, which is incorporated herein by reference in its entirety.

### FIELD

This disclosure relates to the field of water treatment, particularly to methods and apparatus for the treatment of mineral-containing brine to separate minerals contained in the brine from water, and for the treatment of wastewater from gas and oil wells.

### SUMMARY

In one embodiment, a method for the separation of water and minerals from a mineral-containing wastewater stream is disclosed. The method includes the steps of passing the wastewater stream at substantially ambient pressure and at a temperature of at least about 40° C. through a membrane assembly comprising a pervaporation membrane separating a retentate volume from a permeate volume, where water from the wastewater stream diffuses through the pervaporation membrane to form a substantially mineral-free water vapor. Pressure is reduced in the permeate volume of the membrane assembly to below ambient pressure to enhance the flow of the water vapor out of the membrane assembly. A mineral-rich product is removed from the membrane assembly comprising minerals from the wastewater.

The foregoing method may be characterized as having different implementations, refinements and/or additional steps, which may be employed alone or in any combination. In one implementation, the mineral-rich product comprises a retentate stream formed in the retentate volume of the membrane assembly. In one refinement, the step of reducing the pressure in the permeate volume of the membrane assembly comprises reducing the pressure to not greater than about 0.5 bar. In another refinement, the step of reducing the pressure in the permeate volume of the membrane assembly comprises reducing the pressure to not greater than about 0.4 bar. In yet another refinement, the step of reducing the pressure in the permeate volume of the membrane assembly comprises reducing the pressure to not less than about 0.3 bar. In yet another refinement, the wastewater stream has a temperature of at least about 50° C. during the step of passing the mineral-containing wastewater stream through the membrane assembly. In a further refinement, the wastewater stream has a temperature of at least about 60° C. during the step of passing the mineral-containing wastewater stream through the membrane assembly.

In one implementation, the mineral-rich product comprises a solid phase that deposits within the permeate volume of the membrane assembly. In one refinement, the step of reducing the pressure in the permeate volume of the membrane assembly comprises reducing the pressure to not greater than about 0.3 bar. In another refinement, the step of reducing the pressure in the permeate volume of the membrane assembly comprises reducing the pressure to not less than about 0.1 bar. In yet another refinement, the step of reducing the pressure in the permeate volume of the membrane assembly comprises reducing the pressure to not less than about 0.2 bar. In another refinement, the step of passing the mineral-containing wastewater stream through the membrane assembly comprises passing the wastewater stream at a temperature of at least about 65° C. In a further refinement, the step of passing the mineral-containing wastewater stream through the membrane assembly comprises passing the wastewater stream at a temperature of not greater than about 90° C. In one particular refinement, the step of passing the mineral-containing wastewater stream through the membrane assembly comprises passing the wastewater stream at a temperature of at least about 70° C. and not greater than about 80° C.

In another implementation, wherein the step of reducing the pressure in the permeate volume of the membrane assembly comprises using a vacuum pump that is operatively connected to the permeate volume of the membrane assembly. In one refinement, the vacuum pump is a venturi vacuum pump.

In another implementation, the method includes the step of heating the mineral-containing wastewater stream before the step of passing the mineral-containing wastewater stream through the membrane assembly. In one refinement, the heating step comprises heating the mineral-containing wastewater stream using natural gas as an energy source.

In another implementation, the pervaporation membrane is an inorganic membrane. In one refinement, the membrane is a ceramic membrane. In another implementation, the pervaporation membrane is a mesoporous membrane. In one refinement, the pervaporation membrane has a pore size of at least about 2 nanometers. In another refinement, the pervaporation membrane has a pore size of not greater than about 20 nm. In one implementation, the membrane assembly comprises a tubular membrane assembly.

In another implementation, the method includes the step of chilling the water vapor to condense the water vapor into liquid water. In one refinement, the chilling step comprises chilling the water vapor to not greater than about 10° C. In another refinement, the chilling step comprises chilling the water vapor to not greater than about 5° C. In one implementation, at least about 80% of water from the mineral-containing wastewater stream is recovered with the liquid water. In another implementation, the liquid water condensed from the water vapor has a purity of at least about 99.9%.

In one implementation, the mineral-containing wastewater stream comprises a natural brine. In one refinement, the natural brine comprises at least about 30 g/L dissolved salts. In another refinement, the natural brine comprises at least about 30 g/L sodium chloride. In yet another refinement, the natural brine comprises at least about 75 ppm lithium. In a further refinement, the mineral-rich retentate stream comprises at least about 375 ppm lithium, and in yet a further refinement, the mineral-rich retentate stream comprises at least about 750 ppm lithium.

In one implementation, the mineral-containing wastewater stream comprises produced water from an oil/gas extraction operation. In one refinement, the mineral-containing wastewater stream comprises hydrocarbons, and the method includes the step of removing the hydrocarbons from the wastewater before passing the wastewater stream through the membrane assembly. In a further refinement, the hydrocarbons are separated from the wastewater stream before being passed through the membrane assembly. In yet another refinement, the mineral-containing wastewater stream comprises at least about 50 ppm lithium. In a further refinement, the mineral-rich retentate comprises at least about 250 ppm lithium.

In one implementation, the mineral-containing wastewater stream comprises an aqueous solution recovered from an in-situ leaching process. In one refinement, the aqueous solution comprises uranium. In one particular refinement, the aqueous solution comprises at least about 50 ppm uranium. In another refinement, the mineral-rich product comprises at least about 250 ppm uranium. In yet another refinement, the mineral-rich product comprises at least about 500 ppm uranium.

In another implementation, the wastewater stream includes particulate solids and the method includes the step of separating at least a portion of particulate solids from the wastewater stream before passing the wastewater stream through the membrane assembly. In yet another implementation, the mineral-containing wastewater stream has a pH of at least about pH 6 when the wastewater stream is passed through the membrane assembly. In another implementation, the mineral-containing wastewater stream has a pH of not greater than about pH 8 when the mineral-containing wastewater stream is passed through the membrane assembly.

In another embodiment, an apparatus that is configured for the treatment of a mineral-bearing wastewater stream is disclosed. The apparatus includes a membrane assembly, the membrane assembly comprising a pervaporation membrane separating a retentate volume from a permeate volume. A mineral-bearing wastewater stream source is fluidly connected to the membrane assembly to provide a mineral-bearing wastewater stream to the membrane assembly. A heater is configured to heat the mineral-bearing wastewater stream to a temperature above ambient temperature before being passed to the membrane assembly. A chiller is fluidly connected to the membrane assembly and is configured to chill a permeate stream extracted from the permeate volume, and a vacuum pump is operatively connected to the permeate volume and is configured to maintain the permeate volume at a pressure below ambient pressure.

The foregoing apparatus may be characterized as having different configurations, characterizations and/or additional components, which may be employed alone or in any combination. In one configuration, the pervaporation membrane is an inorganic membrane. In another configuration, the membrane is a ceramic membrane. In yet another configuration, the pervaporation membrane has a pore size of at least about 2 nanometers. In a further configuration, the pervaporation membrane has a pore size of not greater than about 20 nm. In another configuration, the water heater is configured to burn methane gas to heat the wastewater stream.

### DESCRIPTION OF THE DRAWINGS

FIG. 1 illustrates a flowsheet of a water and mineral separation system and method according to an embodiment.

FIG. 2 schematically illustrates a heating method and heating system according to an embodiment.

FIG. 3 schematically illustrates a membrane system for a water and mineral separation system according to an embodiment.

FIG. 4 schematically illustrates a water and mineral separation system and method according to an embodiment.

FIG. 5 schematically illustrates a water and mineral separation system and method according to an embodiment.

FIG. 6 schematically illustrates a membrane assembly and method for water and mineral separation according to an embodiment.

FIG. 7 schematically illustrates a membrane system for a water and mineral separation system according to an embodiment.

FIGS. 8A and 8B illustrate a system and method for the separation of minerals and water from a brine solution according to an embodiment.

### DESCRIPTION OF THE EMBODIMENTS

The present disclosure is directed to methods and systems (e.g., apparatus) for the treatment of wastewater (e.g., aqueous solutions) to separate high quality (e.g., high purity) water from the other components of the wastewater. For example, the wastewater may be a brine solution and the method may include the formation of a useful concentrate of the other brine components, such as minerals (e.g., metal salts), that may be treated to recover salable compounds from the concentrate. Other sources of wastewater-containing streams that may be treated and purified include hydrometallurgical leach solutions, mine drainage and produced water that is a by-product of oil and gas extraction operations.

The methods and systems disclosed herein include the use of a membrane assembly, and in particular a membrane assembly that includes a pervaporation membrane. Pervaporation membranes exhibit different permeabilities towards different components of a mixture, and this functionality is utilized to selectively transport one component through the membrane as a vapor (e.g., water vapor), and leave the other components in the retentate, e.g., to dehydrate the mixture. This is in contrast to reverse osmosis (RO), which uses an applied pressure to overcome the osmotic pressure and reverse the natural flow of the solvent (e.g., water) through the membrane. RO is costly to operate, in part due to the high pressures that are necessary to overcome the osmotic pressure.

As is noted above, the wastewater may be the by-product of an industrial process, such as produced water from oil and/or natural gas extraction, effluent from mining operations, effluent from power plant cooling towers, etc. The wastewater may also be a natural product, such as a natural brine or seawater, including natural brines that are extracted by in-situ mining techniques or brine mining techniques. Although the following description refers to the wastewater to be treated as a brine (e.g., a brine solution), it is to be appreciated that the methods and apparatus may be used to treat any type of wastewater or other aqueous solution, including but not limited to the foregoing.

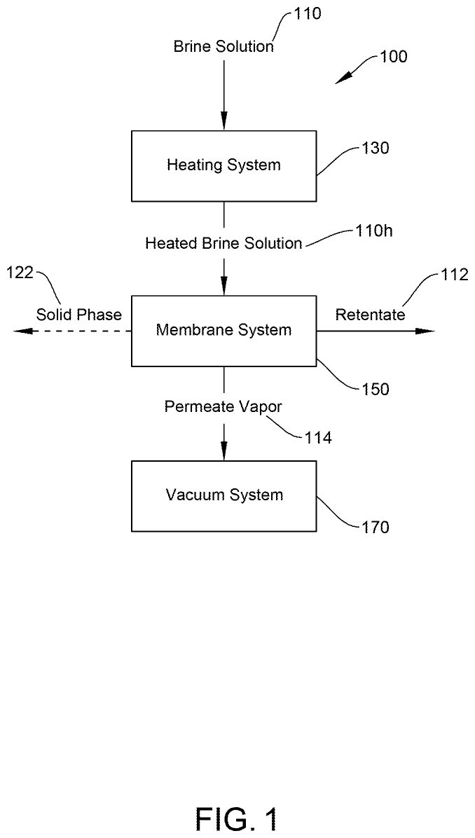

Broadly characterized, the disclosed embodiments include a method for the treatment of a brine solution. Referring to FIG. 1, a brine solution 110 may include salts such as chloride salts, bromide salts, and the like. For example, the brine solution may include salts such as lithium chloride (LiCl), potassium chloride (KCl), sodium chloride (NaCl), magnesium chloride (MgCl₂), and/or calcium chloride (CaCl₂)). Other components of the solution may include, but are not limited to, other chlorides such as iron chlorides (e.g., FeCl₂), metal sulfates, metal nitrates, metal carbonates, bromine compounds, and the like. If the raw (e.g., untreated) brine solution includes particulates (e.g. of sand or the like), the raw brine solution may first be treated to remove the particulates, such as by passing the raw brine solution through one or more filters or similar separation devices. For example, a filter system may include a sand filter, e.g. for the removal of particles having a size of greater than about 100 μm followed by a cartridge filter, e.g., for the removal of particles having a size of from about 20 μm to about 100 μm. If the raw solution includes hydrocarbons, the solution may be treated to remove the hydrocarbons using known techniques before being passed through the membrane assembly.

According to the present disclosure, the brine solution is passed through a membrane system 150. Before being passed through the membrane system 150, the brine solution 110 may be passed through a heating system 130 to raise the temperature of the brine solution 110 to a desired temperature, e.g., a temperature above the ambient temperature.

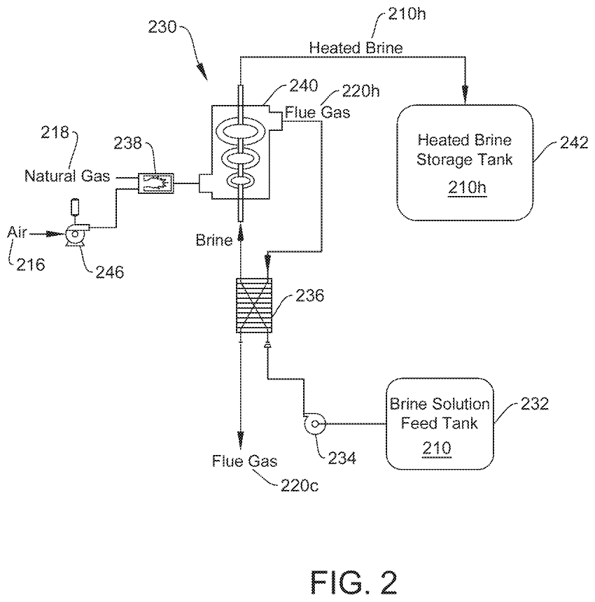

The heating system 130 may include any device that is configured for the heating of a liquid, e.g., the heating of an wastewater stream. One embodiment of a heating system according to the present disclosure is illustrated in FIG. 2. The heating system 230 illustrated in FIG. 2 includes a boiler 240 that is heated (e.g., fired) by a combustor 238 burning natural gas 218, e.g., a methane-containing gas. In this regard, air 216 is provided to a compressor 246 and mixed with natural gas 218 in the combustor 238. In one embodiment, the brine solution 210 is recovered from an oil/gas extraction operation (e.g., produced water), and the natural gas 218 is recovered from the extraction operation, providing an economical source of fuel for the combustor 238. Hot flue gas 220h from boiler 240 may be routed to a heat exchanger 236. At the same time, a feed pump 234 may move brine solution 210 from tank 232 to the heat exchanger 236 to capture waste heat from the hot flue gas 220h to pre-heat the brine solution 210 before the brine solution is introduced to the boiler 240 and form a cooled flue gas 220c. Upon being heated to the desired temperature and exiting the boiler 240, the heated brine 210h may be temporarily stored in a storage tank 242.

Referring back to FIG. 1, after heating the brine 110 in the heating system 130, the heated brine 110h is introduced to a membrane system 150, e.g. a membrane assembly comprising at least one pervaporation membrane module. The pervaporation membrane module may include a polymeric membrane or an inorganic membrane, for example. For the separation of water from the brine solution, the pervaporation membrane may be hydrophilic. In one particular embodiment, the membrane module includes an inorganic pervaporation membrane, such as a ceramic membrane fabricated from silica, alumina, zirconia or the like. Examples of useful membrane modules include, but are not limited to, the HybSi®-AR membrane type module available from Pervatech BV, Rijssen, the Netherlands.

In one embodiment, the pervaporation membrane is a mesoporous membrane. For example, the pervaporation membrane may have a pore size of at least about 1 nanometer, such as at least about 1.5 nanometers or even at least about 2 nanometers. In another embodiment, the pervaporation membrane has a pore size of not greater than about 20 nanometers, such as not greater than about 10 nanometers, such as not greater than about 7 nanometers. In one particular characterization, the pervaporation membrane has a pore size range of from about 2.5 nanometers to about 5 nanometers.

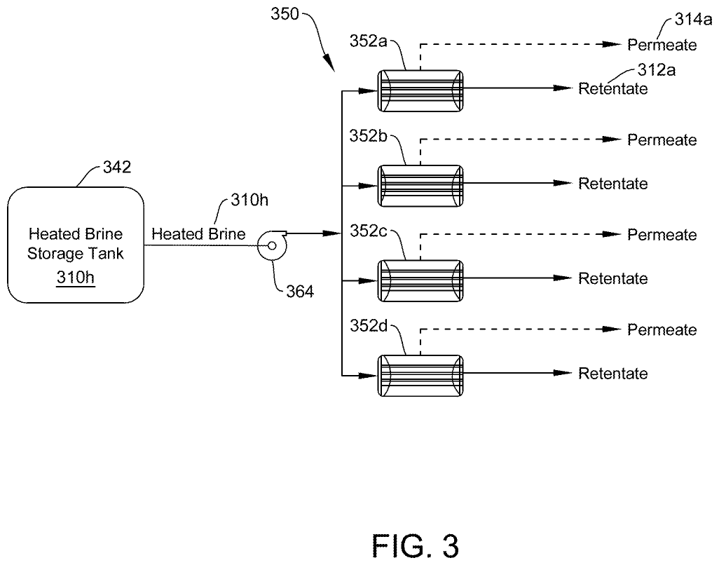

FIG. 3 schematically illustrates a membrane system 350 according to an embodiment of the present disclosure. The membrane system 350 illustrated in FIG. 3 includes four membrane modules 352a, 352b, 352c and 352d that are arranged in parallel relation. Heated brine 310h from a storage tank 342 is fed to the membrane modules 352a-352d by a feed pump 364. In some embodiments, and as illustrated in more detail below, each membrane module may include at least a first flow channel configured to receive the heated brine 310h, the flow channel defining a retentate volume separated from a permeate volume by a membrane. The membrane modules 352a-352d receive the heated brine in the flow channels and the water in the heated brine 310h passes through the membrane to form at least two product streams, namely a permeate stream 314a (e.g., in the permeate volume of the membrane) and a retentate stream 312a (e.g., extracted from the flow channels).

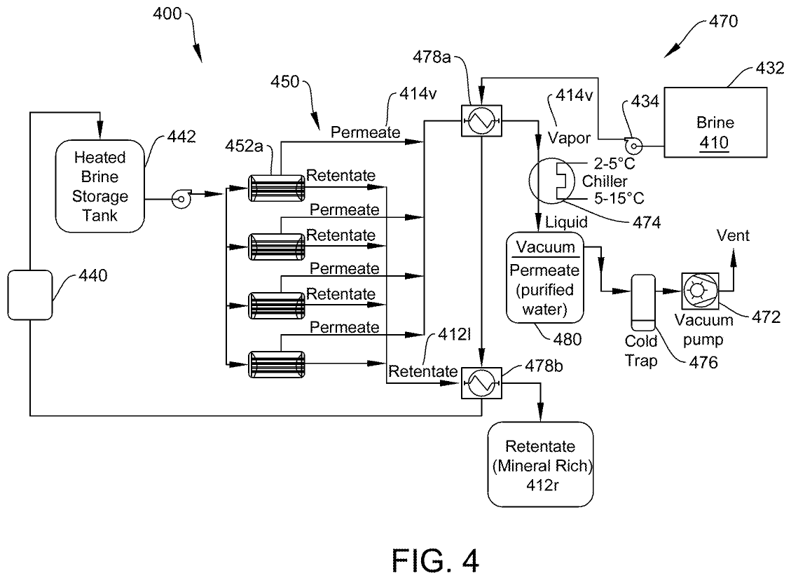

Referring back to FIG. 1, a vacuum system 170 is utilized to reduce the pressure on the permeate side (e.g., in the permeate volume) of the membrane modules, e.g., on the permeate side of the pervaporation membrane modules. FIG. 4 illustrates a method and system 400 for the separation of water and minerals including one embodiment of such a vacuum system. The vacuum system 470 includes a vacuum pump 472 that is operatively connected to the permeate side of the membrane modules, e.g., module 452a. The permeate 414 that is extracted from the modules, e.g., with the assistance of the vacuum system 470 is in the form of a vapor, e.g., water vapor 414v. A chiller 474 is used to condense the water vapor 414v to liquid water 4141, which can be captured in water tank 440, such as for subsequent re-use. A cold trap 476 may disposed between the pump 472 and the chiller 474 to reduce (e.g., substantially eliminate) any residual water from entering the vacuum pump 472, e.g., to extend the useful lifetime of the pump 472.

In one embodiment, the chiller is configured (e.g., is operated) to reduce the temperature of the permeate vapor 414v to not greater than about 12° C., such as not greater than about 10° C., such as not greater than about 2° C. In another embodiment, the chiller 474 is operated to ensure that at least about 95% of the water in the vapor 414v is converted to liquid water 4141, such as at least about 98%, such as at least about 99% or even at least about 99.5%. In some embodiments, the recovered water (e.g., in tank 480) may be have a high purity, and in particular may be substantially free of other brine components from the brine solution 410. For example, the liquid water 4141 may have a purity of at least about 95%, such as at least about 98%, such as at least about 99% or even at least about 99.5%. Further, the amount of water recovered from the brine solution may be at least about 50%, such as at least about 60%, such as at least about 70%, such as at least about 75% or even at least about 80% or at least about 90%. Thus, a large quantity of high purity water may be recovered from the brine solution.

In addition, the system 400 illustrated in FIG. 4 includes the use of a heat exchanger for recovering waste heat from the permeate 414 and retentate 412 and supplying that waste heat to preheat the incoming brine 410. As illustrated in FIG. 4, a first heat exchanger 478a is configured (e.g., placed and operated) to extract waste heat from the permeate vapor 414v before the permeate vapor is introduced to the chiller 474, and transfer that heat to the brine 410. A second heat exchanger 478b is configured to recover heat from the liquid retentate stream 4121 that is extracted from the membrane modules and also supply that heat to the incoming brine 410, e.g., before the brine is heated by the heating system 440.

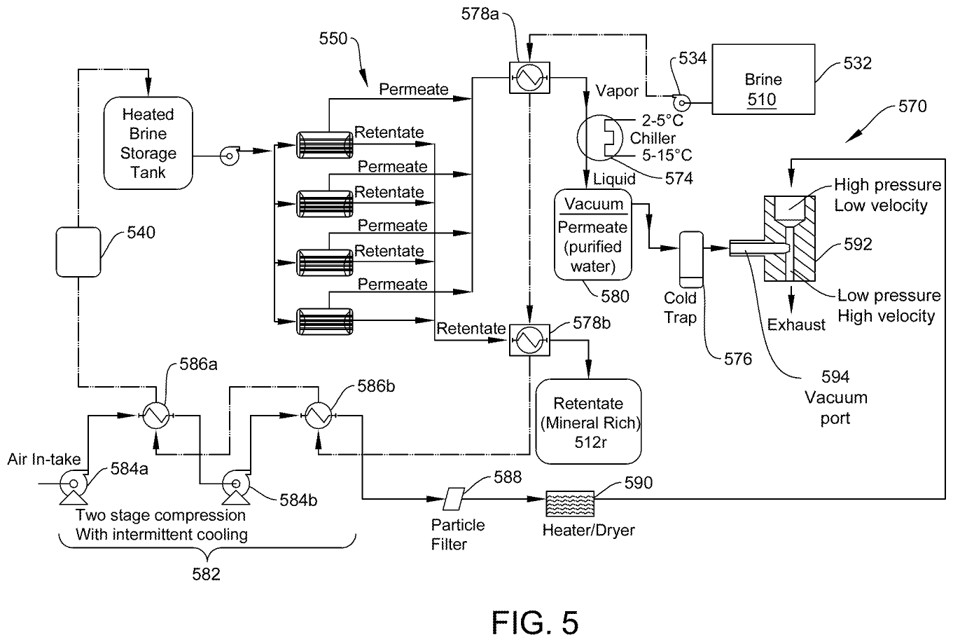

FIG. 5 schematically illustrates an apparatus and system 500 that is similar to the system illustrated in FIG. 4. However, the system illustrated in FIG. 5 includes a vacuum system 570 that eliminates the need for a mechanical vacuum pump. The vacuum system 570 of FIG. 5 includes an air compression system 582 comprising compressors 584a and 584b that are arranged in series, e.g., the first compressor 584a feeds compressed air to the second compressor 584b to compress the air in successive stages. As the compression of the air generates waste heat, heat exchangers 586a and 586bb may be used to cool the compressed air and supply the brine solution 510 with heat, e.g., before the brine is supplied to a boiler 540.

The compression system 582 may compress the air to a pressure of at least about 5 bar, such as at least about 8 bar, such as at least about 10 bar or even at least about 12 bar. Typically, it will not be necessary to compress the air to more than about 30 bar, such as no more than about 25 bar, or no more than about 20 bar. The compression system 582 may also include a particle filter 588 and/or a dryer 590 to remove particulates and/or to dry the air after compression. After compression, the compressed air is supplied to a venturi vacuum pump 592. The compressed air is supplied to the venturi vacuum pump 592 at a relatively high pressure and relatively low velocity, and exits the venturi vacuum pump at a lower pressure and a higher velocity. As a result, the venturi vacuum pump 592 draws a vacuum through a vacuum port 594 that is operatively connected to the membrane modules, e.g., to the permeate side of the membranes, to draw permeate vapor from the membrane modules.

According to certain embodiments of the present disclosure, the composition of the permeate stream and the retentate stream can be controlled through the selection and application of process variables such as the membrane pore size, the temperature of the heated brine entering the membrane system and the value of the reduced pressure on the permeate side of the membrane modules. In one embodiment, minerals from the brine solution are recovered in the retentate stream extracted from the membrane assembly. According to this embodiment, the minerals remain in the retentate and only water vapor is passed through the pervaporation membrane and recovered as the permeate. Broadly characterized, this embodiment includes heating the brine solution to a relatively low temperature and applying a relatively weak vacuum (e.g., higher pressure) to the permeate. In this manner, the minerals (which have a relatively larger molecule size than the water) from the brine solution remain in the retentate. Thus, two product streams are recovered: a mineral-rich retentate and relatively pure water.

For example, the heating system 130 (FIG. 1) may raise the temperature of the brine solution to at least about 40° C., such as at least bout 45° C., such as at least about 50° C. Typically, it will not be necessary to heat the brine solution to an excessive temperature, and in certain embodiments, the brine solution is heated to not greater than about 70° C., such as not greater than about 65° C., such as not greater than about 60° C. Further, the reduced pressure on the permeate side of the membrane modules (e.g., the suction pressure) may be reduced to not greater than about 0.9 bar, such as not greater than about 0.8 bar, such as not greater than about 0.7 bar, such as not greater than about 0.6 bar, not greater than about 0.5 bar, such as not greater than about 0.4 bar. As a practical matter, the pressure in the permeate volume will be not less than about 0.25 bar, such as not less than about 0.3 bar.

In another embodiment, the brine solution is heated to a relatively higher temperature and/or the vacuum applied to the permeate is relatively stronger (e.g., the pressure is lower) as compared to the embodiment described above for the separation of minerals in the retentate. In this manner, a substantial portion of the minerals are drawn through the pervaporation membrane. It has been found that when operating in this manner, the minerals form a solid (e.g., crystalline) phase on the permeate side of the pervaporation membrane (e.g., in the permeate volume), while the permeate vapor is substantially free of minerals.

According to this embodiment, the heating system 130 (FIG. 1) may raise the temperature of the brine solution to at least about 60° C., such as at least bout 65° C., such as at least about 70° C. Typically, it will not be necessary to heat the brine solution to an excessive temperature, and in certain embodiments, the brine solution is heated to not greater than about 90° C., such as not greater than about 85° C., such as not greater than about 80° C. Further, the reduced pressure on the permeate side of the membrane modules may be reduced to not greater than about 0.4 bar, such as not greater than about 0.3 bar. As a practical matter, the pressure in the permeate volume will be not less than about 0.1 bar, such as not less than about 0.15 bar. By operating within these parameters, it has been found that a substantial portion of the minerals will permeate through the pervaporation and collect as a solid.

It has been found that another factor influencing the transport of the minerals through the pervaporation membrane is the flow rate of the feed, e.g., the flow rate of the brine solution into the membrane system. A higher flow rate will tend to force the minerals through the pervaporation membrane, even at temperatures below 75° C., such as in the range of about 50° C. to 60° C. Conversely, relatively low flow rates will require the use of higher temperatures and lower permeate pressures to transport the minerals through the pervaporation membrane.

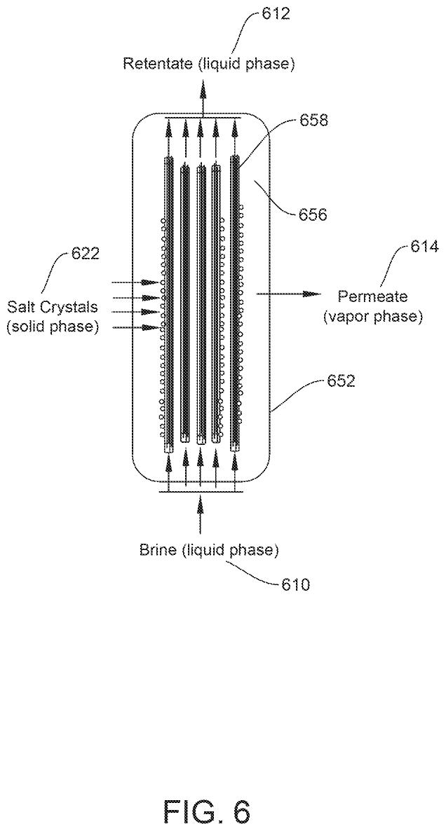

FIG. 6 schematically illustrates an example of the different material phases according to this embodiment. As is illustrated in FIG. 6, the brine solution 610 (liquid phase) is fed to a pervaporation membrane module 652. The membrane module 652 comprises a tubular ceramic structure having a plurality of flow channels defining a retentate volume 658. A retentate stream 612 (liquid phase) is extracted from the retentate volume 658 (e.g., from the opposite end of the flow channels) and a permeate (vapor phase) is extracted from a permeate volume 656 of the assembly. The minerals are deposited as a solid phase 622 (e.g., a crystalline phase) on the permeate side of the flow channels.

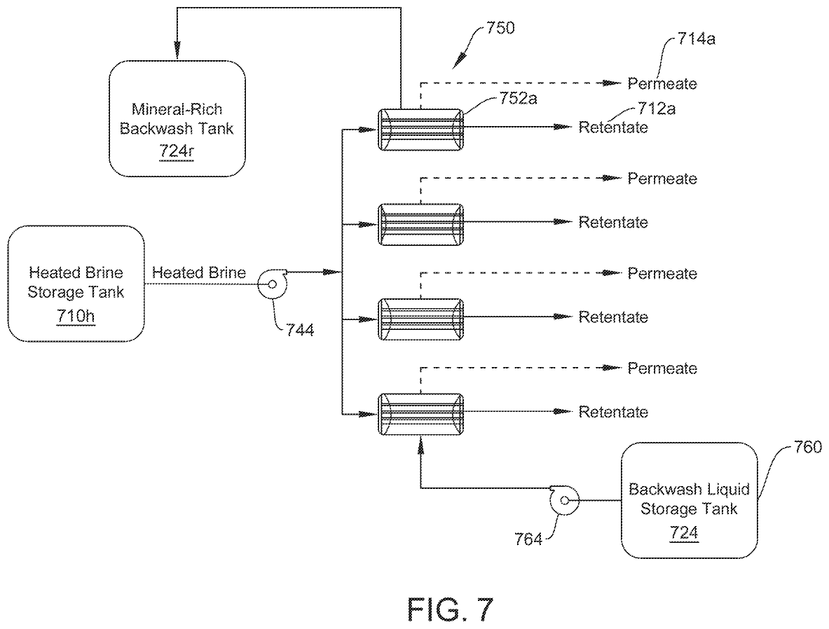

Referring to FIG. 7, a method and system for recovering the solid phase is illustrated. The system illustrated in FIG. 7 includes a tank 760 containing a backwash liquid 724. The tank 760 is fluidly connected to the membrane assembly 750 by a pump 764 that is configured to pump the backwash liquid 724 to the membrane assembly 750. Specifically, the backwash liquid 724 is fluidly connected to the permeate volume of the membrane modules (e.g., module 752a). After collection of the solid phase on the membrane modules, the backwash liquid is pumped through the modules to collect (e.g., to remove) the solid phase minerals from the membrane modules, thereby forming a mineral-rich backwash stream 724r, e.g., having a high concentration of minerals.

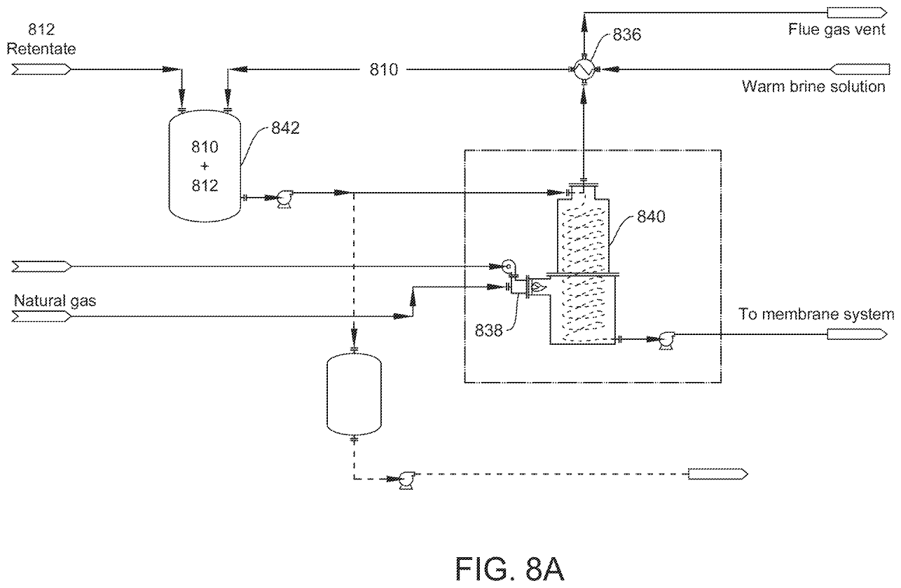

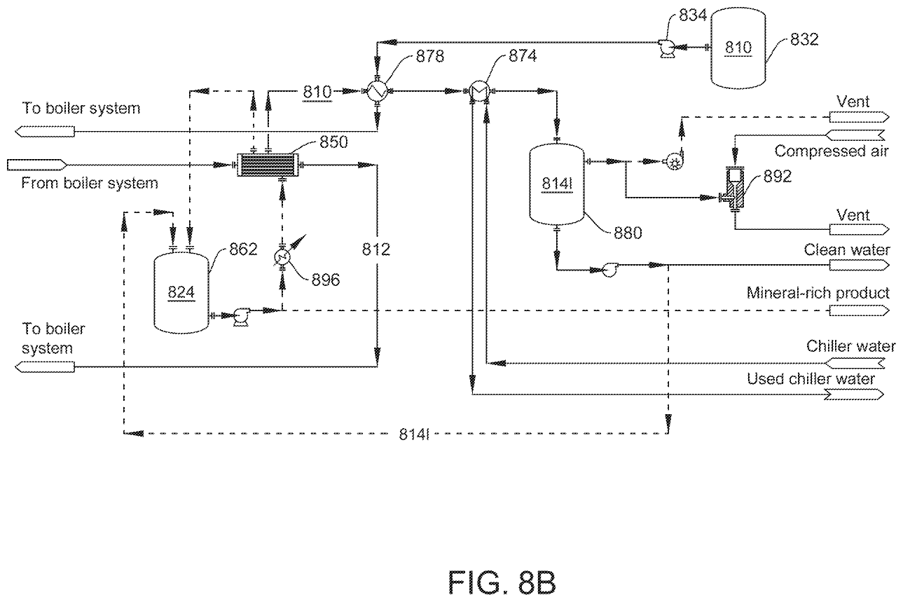

Another embodiment of a system and method for the separation of minerals and water from a brine solution is illustrated in FIGS. 8A and 8B. The method illustrated in FIGS. 8A and 8B includes the formation of a mineral-rich solid phase in the membrane modules, and includes a system for the efficient capture and recycle of waste heat in the system.

Referring first to FIG. 8B, a brine solution 810 is stored in a tank 832, e.g. at ambient temperature. The brine 810 may be transferred by pump 834 to the boiler system (FIG. 8A) after being passed through a heat exchanger 878 which captures waste heat from the permeate 814v (water vapor) exiting the membrane system 850 and warms the brine solution.

As illustrated in FIG. 8B, the warm brine solution is then passed through another heat exchanger 836 which captures waste heat from a flue gas exiting the boiler 840 to further preheat the brine solution. The brine solution is then transferred to a feed tank 842 where it may be stored before being transferred to the boiler 840. At the same time, retentate 812 (FIG. 8B) is transferred from the membrane system 850 to the feed tank 842. Because the retentate 812 is also warm (e.g., above ambient temperature), it supplies additional heat back to the brine solution in the tank 842. Thus, the brine solution stream transferred from the tank 842 to the boiler 850 will require a relatively low quantity of energy (e.g., methane gas) to increase the temperature of the brine solution to the desired level for membrane separation in the membrane assembly 850 (FIG. 8B). As illustrated in FIG. 8B, a backwash system is utilized to remove solid phase minerals from the membrane assembly 850. The backwash system includes a backwash tank 862 that may be supplied with clean (e.g., demineralized) water 8141 from the water tank 880. The backwash liquid may optionally be heated using a heater 896 to facilitate the removal of the minerals from the membrane assembly 850.

By way of example only, the elements and minerals in a feed brine solution may be partitioned as shown in Table I.

TABLE I

| | % DISTRIBUTION | | | | | | | | | |
|---|---|---|---|---|---|---|---|---|---|---|
| Phase | Br | SO₄ | NO₃ | CO₃ | LiCl | KCl | NaCl | MgCl₂ | CaCl₂ | FeCl₂ |
| Feed (liquid) | 100 | 100 | 100 | 100 | 100 | 100 | 100 | 100 | 100 | 100 |
| Retentate (liquid) | 100 | 100 | 100 | 100 | 4 | 15 | 55 | 45 | 90 | 100 |
| Crystals (solids) | | | | | 96 | 85 | 45 | 55 | 10 | 0 |
| Permeate (water vapor) | 0 | 0 | 0 | 0 | 0 | 0 | 0 | 0 | 0 | 0 |

It is noteworthy that a substantial portion of the LiCl from the brine (e.g., at least about 90%) is recovered in the solid phase, whereas a smaller amount of MgCl₂ from the brine (e.g., not greater than 50%) stays in the retentate. This is beneficial to downstream processing to separate Li from Mg, as these two elements are known to be difficult to separate.

As is noted above, the brine solution may come from a variety of sources including natural or artificial brines. In some embodiments, the brine may include at least about 50,000 ppm, minerals, such as at least about 5,000 ppm minerals, or even at least about 500 ppm minerals. Typically, the brine will include not greater than about 1500 ppm minerals. For example, in some embodiments the brine minerals may include lithium, e.g., in concentrations of at least about 5 ppm, 50 ppm, 150 ppm or higher. The recovery of a mineral-rich product having a high concentration of lithium is advantageous for the production of batteries, e.g., lithium-ion batteries. The brine may also include uranium (e.g., from an in-situ leaching process) and the methods and systems described herein may be used to concentrate the uranium for subsequent recovery.

### Examples

A sample (Sample 1) of wastewater from a fracking operation is obtained. Sample 1 is first filtered to remove particulate matter, and is treated to remove hydrocarbons and residual oil using known techniques. After filtering and removal of hydrocarbons, the solution is rich in common alkaline salts of potassium, sodium and calcium. The solution also includes some fluorides, iron and some heavy metals. The solution has a density of 1.0988 g/cm³, and the concentrations of salt species and metals listed in Table II. All metal salts are in chloride form and total chloride concentration is about 77.8 g/L, or about 77,800 ppm. The dominant species is sodium.

TABLE II

| | Sample 1 |
|---|---|
| | Concentration |
| Species | (mg/kg) |
| Bromide | 366 |
| Chloride | 77800 |
| Magnesium | 1770 |
| Lithium | 2.6 |
| Sodium | 46800 |
| Potassium | 314 |
| Calcium | 6790 |
| Aluminum | <0.2 |
| Barium | 3.1 |
| Lead | <0.2 |
| Chromium | <0.2 |
| Iron | 12.0 |
| Selenium | <0.2 |
| Copper | 0.3 |

About 4 liters of the solids-free and crude oil-free wastewater solution is placed in a holding tank from which it is pumped to a pervaporation membrane assembly. The membrane assembly (e.g., module) includes four tubes of a silica-based pervaporation membrane (Pervatech BV, Netherlands). The process circuit includes the holding tank for supplying the solution to the feed side (e.g., retentate side) of the membrane using a feed pump, while a vacuum pump connected to the permeate port. The wastewater is recycled back to the feed tank after passing through the membrane repetitively until most of the freshwater is recovered. The final solution retained in the tank is rich in metal chloride salts and may be disposed of, or may be beneficiated for valuable metals. A second tank with additional wastewater replaces the first tank with the highly concentrated salts and the process is repeated.

In this example, the wastewater solution is heated to about 61° C. and the feed pump is activated to begin circulating the solution through the assembly at a rate of about 190 liters/hr. At the same time, the vacuum pump is turned on and is set to reduce the pump gauge pressure to about 0.45 mbar, resulting in a suction pressure on the membrane of about 0.4 bar. The initial flux of water through the pervaporation membrane is about 9.5 kg/[m²·hr]. After a period of time, the feed pump is stopped and about 760 ml of liquid permeate is collected (“Permeate 1-1”). The feed pump is restarted, and this intermittent process is continued with subsequent permeate volumes of 720 ml (“Permeate 1-2”), 320 ml (“Permeate 1-3”) and 100 ml (“Permeate 1-4”) being collected. The assays are shown in Table III.

TABLE III

| | Concentration | | | |
|---|---|---|---|---|
| | Permeate | Permeate | Permeate | Permeate |
| | 1-1 | 1-2 | 1-3 | 1-4 |
| Species | (mg/kg) | (mg/kg) | (mg/kg) | (mg/kg) |
| Bromide | <0.2 | 0.2 | 0.4 | 0.4 |
| Chloride | 20.8 | 102 | 95.8 | 106 |
| Magnesium | 0.4 | 0.8 | 1.8 | 1.8 |
| Lithium | <0.2 | <0.2 | <0.2 | <0.2 |
| Sodium | 13.6 | 68.1 | 57.4 | 57.4 |
| Potassium | 0.4 | 0.9 | 0.3 | 0.5 |
| Calcium | 2.3 | 6.3 | 11.7 | 11.7 |
| Aluminum | <0.2 | <0.2 | <0.2 | <0.2 |
| Barium | <0.2 | <0.2 | <0.2 | <0.2 |
| Lead | <0.2 | <0.2 | <0.2 | <0.2 |
| Chromium | <0.2 | <0.2 | <0.2 | <0.2 |
| Iron | <0.2 | <0.2 | <0.2 | <0.2 |
| Selenium | <0.2 | <0.2 | <0.2 | <0.2 |
| Copper | <0.2 | <0.2 | <0.2 | <0.2 |

To illustrate the efficacy of the method, the combined the data from Table I and Table IV for chlorides and sodium (e.g., the dominant salt species of sodium chloride) is shown:

TABLE IV

| | Concentration | | | | |
|---|---|---|---|---|---|
| | | Permeate | Permeate | Permeate | Permeate |
| | Sample 1 | 1-1 | 1-2 | 1-3 | 1-4 |
| Species | (mg/kg) | (mg/kg) | (mg/kg) | (mg/kg) | (mg/kg) |
| Chlorides | 77800 | 20.8 | 102 | 95.8 | 106 |
| Sodium | 46800 | 13.6 | 68.1 | 57.4 | 57.4 |

Table IV illustrates that the method was effective to remove a high purity water permeate having significantly reduced chloride concentration. It is believed that the concentration of chloride increased with subsequent permeate samples as a result of chloride salts (e.g., NaCl) forming on the permeate side of the membrane. This is also evidenced by the flux through the membrane decreasing from an initial flux of about 9.5 kg/[m2·hr] to about 6.5 kg/[m²·hr] near the end of the sampling procedure.

After Permeate 1-3 (320 ml) is removed, about 190 ml of deionized water is used to flush the permeate side of the membrane. The resulting flush water was assayed, and the results are shown in Table V.

TABLE V

| | Flush Water |
|---|---|
| | Concentration |
| Species | (mg/kg) |
| Bromide | 31.7 |
| Chloride | 17800 |
| Magnesium | 200 |
| Lithium | 0.2 |
| Sodium | 12200 |
| Potassium | 31.8 |
| Calcium | 826 |
| Aluminum | <0.2 |
| Barium | 0.4 |
| Lead | <0.2 |
| Chromium | <0.2 |
| Iron | <0.2 |
| Selenium | <0.2 |
| Copper | <0.2 |

At the same time (i.e., after Permeate 1-3 was collected), the retentate contained a concentration of 152000 mg/kg chloride and 87100 mg/kg sodium.

Table VI illustrates the assay of a small sample of the crystalline layer that develops along the external surface (permeate side) of the pervaporation membrane taken after completion of the testing.

TABLE VI

| | Solid Permeate |
|---|---|
| | Concentration |
| Species | (mg/kg) |
| Bromide | 921 |
| Chloride | 506000 |
| Magnesium | 5130 |
| Lithium | 4.2 |
| Sodium | 352000 |
| Potassium | 1090 |
| Calcium | 17500 |
| Aluminum | 19.6 |
| Barium | 8.9 |
| Lead | 8.1 |
| Chromium | 10.5 |
| Iron | 151 |
| Selenium | <0.2 |
| Copper | 1.9 |

It is clear from the assays shown in Table V and Table VI that sodium is selectively diffused through the pervaporation membrane and is retained in the crystalline phase on the permeate side of the membrane, while heavy metals remain in the retentate. This is evidenced by partition of 88-95% of sodium to the crystal phase while less than 1% of each of the metals reports the crystalline phase. This result signifies the ability to recover water selectively through the permeate and specific metal crystals such as sodium chloride and lithium chloride to the crystal phase. A small volume of backwash water is applied to recover crystals from membrane surfaces at ambient or otherwise moderate temperature. This practice mimics solvent extraction, where the membrane serves as a media for separating sodium or lithium from bulk metal elements in a feed liquor to a third phase. The crystals are stripped by a small volume of electrolyte to produce a sufficiently concentrated electrolyte suitable for subsequent reduction to the metal by electrolysis or precipitation.

Another sample (“Sample 2”) of wastewater solution from a fracking process is obtained having a density of 1.031 g/ml and a concentration of salt species and metals listed in Table VII. The total metal chloride concentration is about 25.2 g/L or about 25,200 ppm. The dominant species is sodium.

TABLE VII

| | Feed |
|---|---|
| | Concentration |
| Species | (mg/kg) |
| Bromide | 174 |
| Chloride | 25200 |
| Magnesium | 424 |
| Lithium | 5.0 |
| Sodium | 16000 |
| Potassium | 272 |
| Calcium | 1130 |
| Aluminum | <0.2 |
| Barium | 1.3 |
| Lead | <0.2 |
| Chromium | <0.2 |
| Iron | 0.5 |
| Selenium | <0.2 |
| Copper | <0.2 |

In a manner similar to that described above for Sample 1, about 4 liters of the solution is placed in a pervaporation membrane assembly. The membrane assembly includes multiple silica-based pervaporation membrane tubes (Pervatech BV, Netherlands). The assembly also includes a tank for supplying the solution to the feed side of the porous membrane tubes using a feed pump and a vacuum pump is connected to the permeate port. The solution is heated to about 61° C. and the feed pump is activated to begin circulating the solution through the assembly at a rate of about 190 liters/hr. At the same time, the vacuum pump is turned on and is set to a gauge pressure of about 0.45 mbar, resulting in a suction pressure on the permeate side of the membrane of about 0.4 bar. The initial flux of water through the pervaporation membrane is about 8.45 kg/[m²·hr]. After a period of time, the feed pump is stopped and about 690 ml of liquid permeate is collected (“Permeate 2-1”). The feed pump is restarted, and this intermittent process is continued with subsequent permeate volumes of 710 ml (“Permeate 2-2”), 250 ml (“Permeate 2-3”) 210 ml (“Permeate 2-4”) and 430 ml (“Permeate 2-5”) being collected. The assays are shown in Table VIII.

TABLE VIII

| | Concentration | | | | |
|---|---|---|---|---|---|
| | Permeate | Permeate | Permeate | Permeate | Permeate |
| | 2-1 | 2-2 | 2-3 | 2-4 | 2-5 |
| Species | (mg/kg) | (mg/kg) | (mg/kg) | (mg/kg) | (mg/kg) |
| Bromide | 0.5 | 0.2 | 0.6 | 0.4 | <0.2 |
| Chloride | 66.9 | 22.9 | 61.0 | 39.5 | 10.4 |
| Magnesium | 2.2 | 1.1 | 3.2 | 1.9 | 0.4 |
| Lithium | <0.2 | <0.2 | <0.2 | <0.2 | <0.2 |
| Sodium | 35.9 | 9.4 | 24.5 | 18.0 | 5.7 |
| Potassium | <0.2 | 0.8 | 0.4 | <0.2 | 1.4 |
| Calcium | 10.1 | 4.6 | 13.6 | 8.5 | 2.1 |
| Aluminum | <0.2 | <0.2 | <0.2 | <0.2 | 0.2 |
| Barium | <0.2 | <0.2 | <0.2 | <0.2 | <0.2 |
| Lead | <0.2 | <0.2 | <0.2 | <0.2 | <0.2 |
| Chromium | <0.2 | <0.2 | <0.2 | <0.2 | <0.2 |
| Iron | <0.2 | <0.2 | <0.2 | <0.2 | <0.2 |
| Selenium | <0.2 | <0.2 | <0.2 | <0.2 | <0.2 |
| Copper | <0.2 | <0.2 | <0.2 | <0.2 | <0.2 |

To illustrate the efficacy of the method, the combined the data from Table VII and Table VIII for chlorides and sodium (e.g., the dominant salt species of sodium chloride) is shown.

TABLE IX

| | Concentration | | | | | |
|---|---|---|---|---|---|---|
| | | Permeate | Permeate | Permeate | Permeate | Permeate |
| | Sample 2 | 2-1 | 2-2 | 2-3 | 2-4 | 2-5 |
| Species | (mg/kg) | (mg/kg) | (mg/kg) | (mg/kg) | (mg/kg) | (mg/kg) |
| Chlorides | 25200 | 66.9 | 22.9 | 61.0 | 39.5 | 10.4 |
| Sodium | 16000 | 35.9 | 9.4 | 24.5 | 18.0 | 5.7 |

Table IX illustrates that the method was effective to remove a high purity water permeate having significantly reduced chloride concentration.

While various embodiments of a method and system for the separation of water and minerals from a wastewater have been described in detail, it is apparent that modifications and adaptations of those embodiments will occur to those skilled in the art. However, it is to be expressly understood that such modifications and adaptations in energy recycle, membrane configurations and backwash of crystals, vacuum generation system, retentate recycle, non-traditional wastewater sources, continuous bulk fresh water recovery etc. are within the spirit and scope of the present disclosure.

1. A method for the separation of water and minerals from a mineral-containing wastewater stream, comprising the steps of:
passing the wastewater stream at substantially ambient pressure and at a temperature of at least about 40° C. through a membrane assembly comprising a pervaporation membrane separating a retentate volume from a permeate volume, where water from the wastewater stream diffuses through the pervaporation membrane to form a substantially mineral-free water vapor;
reducing the pressure in the permeate volume of the membrane assembly to below ambient pressure to enhance the flow of the water vapor out of the membrane assembly; and
removing a mineral-rich product comprising minerals from the wastewater from the membrane assembly.

2. The method recited in claim 1, wherein the mineral-rich product comprises a retentate stream formed in the retentate volume of the membrane assembly.

3. The method recited in claim 2, wherein the step of reducing the pressure in the permeate volume of the membrane assembly comprises reducing the pressure to not greater than about 0.5 bar.

4. (canceled)

5. (canceled)

6. The method recited in claim 1, wherein the wastewater stream has a temperature of at least about 50° C. during the step of passing the mineral containing wastewater stream through the membrane assembly.

7. (canceled)

8. The method recited in claim 1, wherein the mineral-rich product comprises a solid phase that deposits within the permeate volume of the membrane assembly.

9. The method recited in claim 8, wherein the step of reducing the pressure in the permeate volume of the membrane assembly comprises reducing the pressure to not greater than about 0.3 bar.

10. (canceled)

11. (canceled)

12. The method recited in claim 1, wherein the step of passing the mineral-containing wastewater stream through the membrane assembly comprises passing the wastewater stream at a temperature of at least about 65° C.

13. (canceled)

14. (canceled)

15. (canceled)

16. (canceled)

17. The method recited in claim 1, comprising the step of heating the mineral-containing wastewater stream before the step of passing the mineral containing wastewater stream through the membrane assembly.

18. (canceled)

19. The method recited in claim 1, wherein the pervaporation membrane is an inorganic membrane.

20. (canceled)

21. (canceled)

22. (canceled)

23. The method recited in claim 1, wherein the pervaporation membrane has a pore size of not greater than about 20 nm.

24. (canceled)

25. The method recited in claim 1, comprising the step of chilling the water vapor to condense the vapor into liquid water.

26. (canceled)

27. (canceled)

28. The method recited in claim 1, wherein at least about 80% of water from the mineral-containing wastewater stream is recovered with the liquid water.

29. The method recited in claim 25, wherein the liquid water condensed from the water vapor has a purity of at least about 99.9%.

30. The method recited in claim 1, wherein the mineral containing wastewater stream comprises a natural brine.

31. The method recited in claim 30, wherein the natural brine comprises at least about 30 g/L dissolved salts.

32. (canceled)

33. (canceled)

34. (canceled)

35. (canceled)

36. The method recited in claim 1, wherein the mineral containing wastewater stream comprises produced water from an oil/gas extraction operation.

37. (canceled)

38. (canceled)

39. (canceled)

40. The method recited in claim 1, wherein the mineral containing wastewater stream comprises an aqueous solution recovered from an in-situ leaching process.

41. (canceled)

42. (canceled)

43. (canceled)

44. (canceled)

45. (canceled)

46. The method recited in claim 1, wherein the mineral containing wastewater stream has a pH of at least about pH 6 when the wastewater stream is passed through the membrane assembly.

47. The method recited in claim 1, wherein the mineral containing wastewater stream has a pH of not greater than about pH 8 when the mineral containing wastewater stream is passed through the membrane assembly.

48. An apparatus configured for the treatment of a mineral-bearing wastewater stream, comprising:
a membrane assembly, the membrane assembly comprising a pervaporation membrane separating a retentate volume from a permeate volume;
a mineral-bearing wastewater stream source fluidly connected to the membrane assembly to provide a mineral-bearing wastewater stream to the membrane assembly;
a heater configured to heat the mineral-bearing wastewater stream to a temperature above ambient temperature before being passed through the membrane assembly;
a chiller fluidly connected to the membrane assembly and configured to chill a permeate stream extracted from the permeate volume; and
a vacuum pump operatively connected to the permeate volume and configured to maintain the permeate volume at a pressure below ambient pressure.

49. (canceled)

50. (canceled)

51. (canceled)

52. (canceled)

53. (canceled)
